(19) United States
(12) Patent Application Publication
(10) Pub. No.: US 2021/0301132 A1
(43) Pub. Date: Sep. 30, 2021

(54) TRANSPARENT AND TINT-FREE POLYIMIDE FILM, PREPARATION METHOD THEREOF AND OPTICAL POLYIMIDE FILM

(71) Applicant: Zhongtian Electronic Materials Co.,LTD., Nantong (CN)

(72) Inventors: CAI-PING ZENG, Nantong (CN); YING JIN, Nantong (CN)

(21) Appl. No.: 16/929,366

(22) Filed: Jul. 15, 2020

Related U.S. Application Data
(63) Continuation-in-part of application No. PCT/CN2020/101893, filed on Jul. 14, 2020.

(30) Foreign Application Priority Data
Mar. 27, 2020 (CN) 202010230931.6

(51) Int. Cl. C08L 79/08; C08G 73/10; C08J 5/18; G02B 1/04; G02B 1/115

(52) U.S. Cl. CPC C08L 79/08; C08G 73/1067; C08G 73/1039; C08L 2203/16; G02B 1/04; G02B 1/115; C08L 2201/10; C08J 5/18

(57) ABSTRACT

A transparent and tint-free polyimide film, a preparation method thereof and an optical PI film are provided in the disclosure. The transparent and tint-free polyimide film not only has excellent light transmittance (≥85% @500 nm), but also has high modulus (tensile modulus≥3.8 GPa) and low coefficient of thermal expansion (≤30 ppm/Celsius, 50-200 Celsius) and other characteristics, so as to the transparent and tint-free polyimide film can meet the needs of flexible optoelectronic display devices.

### CROSS-REFERENCE TO RELATED APPLICATIONS

This application claims priority to CN Patent Application Serial Number 202010230931.6, filed at SIPO on Mar. 27, 2020, the disclosure of which is incorporated herein by reference.

### FIELD

The subject matter herein generally relates to material field, in particular to a transparent and tint-free polyimide film, a preparation method thereof, and an optical polyimide (PI) film.

### BACKGROUND

Polyimide (PI) films are widely used in flexible printed circuits, flexible optoelectronic displays, aerospace, etc. due to their high toughness, high heat resistance, low dielectric constant, and low transmission losses. A single-sided or double-sided flexible copper clad laminate (FCCL) is formed by bonding one or both sides of a polyimide film layer with a copper foil, and then a single-sided or double-sided flexible printed circuit (FPC) is obtained through exposure, etching, etc. The single-sided or double-sided flexible printed circuit (FPC) is laminated with an adhesive film, and a high-density multilayer printed circuit can be obtained by heating and molding. Due to the interaction of charges in the main chain structure of the resin and between the main chain structures, the traditional aromatic polyimide film is generally yellow or tan. In recent years, flexible optoelectronic displays have urgent demands for transparent polyimide films. The flexible photoelectric display substrate is mainly made of transparent conductive electrodes (such as indium oxide ITO, etc.) and thin film transistor (TFT) circuits on the surface of the polyimide film, which is used to control pixel switches. Polysilicon, oxides, etc., which are usually used to make the TFT circuit layer, have a low thermal expansion coefficient (<12 ppm/Celsius), and manufacturing processes need to undergo a high temperature of 230 Celsius. If the coefficient of thermal expansion of a transparent polyimide film is significantly different from the TFT, it may cause problems such as cracking of the device.

In order to meet the requirement of flexible optoelectronic display substrates, people have introduced large-volume side chains, fluorine-containing groups, and flexible segments into the resin main chain structure to destroy the interaction of charges in the resin and realize the polyimide film which is not only transparent and optically clear but free of any tint. However, although the currently reported transparent polyimide film has excellent light transmittance, it generally has shortcomings such as low modulus, low elongation at break, and a high coefficient of thermal expansion, which severely restricts the wide use of such materials in flexible optoelectronic displays.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessary to scale and the proportions of certain parts have been exaggerated to better illustrate details and features of the present disclosure. The description is not to be considered as limiting the scope of the embodiments described herein.

Several definitions that apply throughout this disclosure will now be presented. The term “comprising” means “including, but not necessarily limited to”; it specifically indicates open-ended inclusion or membership in a so-described combination, group, series, and the like. The term “coupled” is defined as connected, whether directly or indirectly through intervening components, and is not necessarily limited to physical connecting. The coupling can be such that the objects are permanently connected or releasably connected. The term “substantially” means essentially conforming to the particular dimension, shape, or other feature that the term modifies, but such that the component needs not have that exact feature.

It should be noted that, when an element is considered to be “fixed to” another element, which can be either directly fixed on another element or indirectly fixed on another element with a centered element. When an element is considered to be “coupled with” another element, which can be either directly coupled with another element or indirectly coupled with another element with a centered element at the same time.

Unless otherwise defined, all technical and scientific terms used herein have the same meaning as commonly understood by one skilled in the art. The terms used in a specification of the present application herein are only for describing specific embodiments, and are not intended to limit the present application. The terms “and/or” used herein includes any and all combinations of one or more of associated listed items.

The present disclosure is described with reference to the specific embodiments.

In an embodiment, a preparation method of a transparent and tint-free polyimide film of the present disclosure includes the following steps:

Step 11: preparing a tetracid dianhydride and a tetracid dianhydride derivative. Wherein the tetracid dianhydride includes an alicyclic tetracid dianhydride and an aromatic tetracid dianhydride. In some embodiments, the molar number of the alicyclic tetracid dianhydride accounts for 10-50% of the sum of the molar number of the alicyclic tetracid dianhydride and the aromatic tetracid dianhydride. The aromatic tetracid dianhydride includes one or more of pyromellitic dianhydride (PMDA), 3,3′,4,4′-biphenyltetracarboxylic dianhydride (s-BPDA), 2,3,3′,4′-biphenyltetracarboxylic dianhydride (α-BPDA), 3,3′,4,4′-diphenylsulfone tetracarboxylic dianhydride (s-DSDA), 2,3,3′,4′-diaphenyl sulfone tetracarboxylic dianhydride (α-DSDA). The alicyclic tetracid dianhydride includes 1,8-dimethylbicyclo[2,2,2]oct-7-ene-2,3,5,6-tetracarboxylic dianhydride (DMBD), 1,4,5,8-dimethylene bridge-perhydronaphthalene-2,3,6,7-tetracarboxylic acid dianhydride (DNDA), bicyclo[2,2,2] octane-2,3,5,6-tetracarboxylic dianhydride (BTAH), cyclic hexane-1,2,4,5-tetracarboxylic dianhydride (HPMDA) and cyclobutane-1,2,3,4-tetracarboxylic dianhydride (CBDA). When the molar number of alicyclic tetracid dianhydride accounts for less than 10% of the total molar number of the tetracid dianhydride, the light transmittance is significantly decreased. While the molar number of alicyclic tetracid dianhydride accounts for more than 50% of the total molar number of the tetracid dianhydride, it decreases the tensile modulus of the transparent and tint-free polyimide film, and increases the coefficient of thermal expansion (CTE).

Step 13: adding a fluorinated aromatic diamine into a polar aprotic solvent to form a homogeneous solution, and then adding a tetracid dianhydride in batches into the homogeneous solution to form a polyamide acid resin solution through polycondensation reaction between the fluorinated aromatic diamine and the tetracid dianhydride. The polyamide acid resin solution has a solid content of 15 wt. % to 30 wt. %, that is due to the solid content being less than 15 wt. %, the reaction activity of monomers of the polyamide acid resin solution and the tetracid dianhydride will decline, and the degree of polymerization of the polyamide acid resin will become low, and the polyimide film will be broken by low tensile strength. When the solid content is more than 30 wt. %, the apparent viscosity of the polyamide acid resin will become high, but the intrinsic viscosity of the polyamide acid resin will become low, and the polyimide film will be broken by bad toughness. Wherein the fluorinated aromatic diamine mainly includes 2,2′-bistrifluoromethyl-4,4′-diaminobiphenyl (TFDB), and one or more of 1,4-bis(2-trifluoromethyl-4-aminophenoxygroup)benzene (6FAFB), 1,3-bis(2-trifluoromethyl-4-aminophenoxy)benzene (6FMPB), 4,4′-bis(2-trifluoromethyl-4-aminophenoxy)biphenyl (6FBAB), where the molar number of 2,2′-bistrifluoromethyl-4,4′-diaminobiphenyl accounts for 50% to 90% of the total molar number of the fluorinated aromatic diamine. When the molar number of TFDB accounts for less than 50% of the total molar number of the fluorinated aromatic diamine, it can decrease the tensile modulus and increase the CTE; when the molar number of TFDB accounts for more than 90% of the total molar number of the fluorinated aromatic diamine, it can decrease the light transmittance. The polar aprotic solvent includes one or more of N-methylpyrrolidone, N,N′-diamethyl acetamide, N,N′-diamethylformamide and diamethyl dulfoxide. In some embodiments, the solid content of the polyamide acid resin solution is preferably 18 wt. % to 26 wt. %. In other embodiments, the solid content of the polyamide acid resin solution is further preferably 20 wt. % to 23 wt. %.

Step 15: adding a chemical imidization reagent into the polyamide acid resin solution, and that being stirred evenly, and vacuum defoamed, and coated on a surface of a support, and forming a semi-cured self-supporting adhesive film after heat treatment. Wherein the chemical imidization reagent includes an organic acid anhydride and an organic base; the organic acid anhydride includes one or more of acetic anhydride, propionic anhydride, butyric anhydride, benzoic anhydride, and maleic anhydride; the organic base includes pyridine, 2-picoline, 3-picoline, and isoquinoline.

Step 17: peeling off the semi-cured self-supporting adhesive film from the surface of the support, fixing the surroundings of the semi-cured self-supporting adhesive film or stretching biaxially the semi-cured self-supporting adhesive film at high temperature treatment to complete the imidization reaction; and cooling to obtain the transparent and tint-free polyimide film.

In another embodiment, a preparation method of a transparent and tint-free polyimide film of the present disclosure includes the following steps:

Step 21: preparing a tetracid dianhydride derivative. Wherein the tetracid dianhydride derivative is a mixture of an alicyclic diacid chloride diester solution obtained by reaction with the esterification and acid chlorination of an alicyclic tetracid dianhydride in an organic solvent, and an aromatic diacid chloride diester solution obtained by reaction with the esterification and acid chlorination of an aromatic tetracid dianhydride in an organic solvent.

In some embodiments, an alicyclic tetracid dianhydride and an aromatic tetracid dianhydride are each dissolved in an organic solvent with a low-fat alcohol. An esterification reaction takes place under heating to form an alicyclic diacid diester solution and an aromatic diacid diester solution; and then, sulfoxide chlorides are added for chlorination reactions so that the alicyclic diacid diester solution and the aromatic diacid diester solution are converted to an alicyclic diester chloride diester solution and an aromatic diester chloride diester solution respectively. The alicyclic diester chloride diester solution and the aromatic diester chloride diester solution are mixed to obtain the tetracid dianhydride derivative. The molar number of the alicyclic tetracid dianhydride accounts for 10-50% of the sum of the molar number of the alicyclic tetracid dianhydride and the aromatic tetracid dianhydride. The aromatic tetracid dianhydride includes one or more of pyromellitic dianhydride (PMDA), 3,3′,4,4′-biphenyltetracarboxylic dianhydride (s-BPDA), 2,3,3′,4′-biphenyltetracarboxylic dianhydride (α-BPDA), 3,3′,4,4′-diphenylsulfone tetracarboxylic dianhydride (s-DSDA), 2,3,3′,4′-diaphenylsulfone tetracarboxylic dianhydride (α-DSDA). The alicyclic tetracid dianhydride includes 1,8-dimethylbicyclo[2,2,2]oct-7-ene-2,3,5,6-tetracarboxylic dianhydride (DMBD), 1,4,5,8-dimethylene bridge-perhydronaphthalene-2,3,6,7-tetracarboxylic acid dianhydride (DNDA), bicyclo[2,2,2] octane-2,3,5,6-tetracarboxylic dianhydride (BTAH), cyclic hexane-1,2,4,5-tetracarboxylic dianhydride (HPMDA) and cyclobutane-1,2,3,4-tetracarboxylic dianhydride (CBDA). When the molar number of alicyclic tetracid dianhydride accounts for less than 10% of the total molar number of the tetracid dianhydride, the light transmittance is significantly decreased. While the molar number of alicyclic tetracid dianhydride accounts for more than 50% of the total molar number of the tetracid dianhydride, the tensile modulus of the transparent and tint-free polyimide film is decreased, the coefficient of thermal expansion (CTE) is increased. The organic solvent includes one or more of N-methylpyrrolidone, N,N′-dimethylacetamide, N,N′-dimethylformamide, dimethyl sulfoxide, γ-butyrolactone, ethyl lactate, cyclopentanone, cyclohexanone, methyl ethyl ketone, ethyl acetate, and butyl acetate. In some embodiments, the low-fat alcohol may also be but is not limited to methanol, ethanol, propanol, isopropanol, butanol, etc.

Step 23: adding a fluorinated aromatic diamine into the tetracid dianhydride derivative to form a polyamide ester resin solution with polycondensation reaction between the fluorinated aromatic diamine and the tetracid dianhydride derivative, and purification. The solid content of the polyamide ester resin solution is 15 wt. % to 30 wt. %. When the solid content is less than 15 wt. %, the reaction activity of monomers of the fluorinated aromatic diamine and the tetracid dianhydride derivative will decline, and the degree of polymerization of the polyamide ester resin will become low, and the polyimide film will be broken by low tensile strength. When the solid content is more than 30 wt. %, the apparent viscosity of polymers of the polyamide ester resin will become high, but the intrinsic viscosity of polymers of the polyamide ester resin will become low, the polyimide film will be broken by bad toughness. In some embodiments, the solid content of the polyamide ester resin solution is preferably 18 wt. % to 26 wt. %. In other embodiments, the solid content of the polyamide acid resin solution is further preferably 20 wt. % to 23 wt. %. Wherein the fluorinated aromatic diamine mainly includes 2,2′-bistrifluoromethyl-4,4′-diaminobiphenyl (TFDB), and one or more of 1,4-bis(2-trifluoromethyl-4-aminophenoxygroup)benzene (6FAFB), 1,3-bis(2-trifluoromethyl-4-aminophenoxy)benzene (6FMPB), 4,4′-bis(2-trifluoromethyl-4-aminophenoxy)biphenyl (6FBAB), where the molar number of 2,2′-bistrifluoromethyl-4,4′-diaminobiphenyl accounts for 50% to 90% of the total molar number of the fluorinated aromatic diamine. When the molar number of TFDB accounts for less than 50% of the total molar number of the fluorinated aromatic diamine, it can decrease the tensile modulus and increase the CTE; when the molar number of TFDB accounts for more than 90% of the total molar number of the fluorinated aromatic diamine, it can decrease the light transmittance.

In some embodiments, the purification comprises precipitating, filtering and washing the solution formed by the polycondensation reaction between the fluorinated aromatic diamine and the tetracid dianhydride derivative to obtain first resin solids; dissolving first resin solids in an organic solvent to form a homogenous solution, and purifying the homogenous solution by ion adsorption, separating out, and drying to obtain second resin solids; and dissolving second resin solids in an organic solvent to form the polyamide ester resin solution.

Step 25: adding a chemical imidization reagent into the polyamide ester resin solution, and the same being stirred evenly, and vacuum defoamed, and coated on a surface of a support, and forming a semi-cured self-supporting adhesive film after heat treatment. Wherein the chemical imidization reagent includes an organic acid anhydride and an organic base; the organic acid anhydride includes one or more of acetic anhydride, propionic anhydride, butyric anhydride, benzoic anhydride, and maleic anhydride; the organic base includes pyridine, 2-picoline, 3-picoline, and isoquinoline.

Step 27: peeling off the semi-cured self-supporting adhesive film from the surface of the support, fixing the surroundings of the semi-cured self-supporting adhesive film or stretching biaxially the semi-cured self-supporting adhesive film at high temperature treatment to complete the imidization reaction; and cooling to obtain the transparent and tint-free polyimide film.

In the above embodiments, the obtained transparent and tint-free polyimide films have following characteristics: a tensile modulus≥3.8 GPa; a coefficient of thermal expansion at 50-200 Celsius≤30 ppm/Celsius; and a light transmittance at 500 nm wavelength≥85%. Specifically, the transparent and tint-free polyimide films have following characteristics: a tensile modulus of 3.8 GPa to 8.5 GPa; a coefficient of thermal expansion at 50-200 Celsius of 1 ppm/Celsius to 30 ppm/Celsius; and a light transmittance at 500 nm wavelength of 85% to 96%.

The above-mentioned transparent and tint-free polyimide films can be used for many applications of optical PI films. The optical PI film comprises a metal layer, an indium tin oxide transparent electrode and the above-mentioned transparent and tint-free polyimide film, the metal layer is deposited by ion implantation or magnetron sputtering on one side or both sides of the activated transparent and tint-free polyimide film, the indium tin oxide transparent electrode is vacuum deposited on the surface of the metal layer facing away from the transparent and tint-free polyimide film. The optical PI film can be applied to, but not limited to, a flexible transparent optoelectronic display substrate, a flexible optoelectronic display protective film or a flexible electronic packaging substrate.

The transparent and tint-free polyimide film, its preparation process, and the performance of the final product are disclosed in combination with specific embodiments.

Example 1: 200 ml DMF, 28.81 g TFDB and 4.28 g 6FAPB are added in a 500 ml three-necked round bottom flask equipped with a mechanical stirrer, thermometer and nitrogen protection device, and all solids are dissolved under stirring and nitrogen protection to form a homogeneous solution. The above round bottom flask is cooled to 0-10 Celsius with an ice bath, and 11.21 g of HPMDA and 14.71 g of s-BPDA solid powder are added in batches to the above homogeneous solution with stirring. After all solids were completely dissolved, there is a duration of 10 hours for a polycondensation reaction under stirring to obtain a viscous homogeneous polyamide acid (PAA) resin solution.

100 g of the PAA resin solution is taken to a 200 ml glass flask. 20 g mixture of acetic anhydride and pyridine are added in the PAA resin solution under stirring. Then the solution is mixed evenly, filtered, and vacuum defoamed. The solution is coated on a surface of a stainless steel support to form a resin film with a certain thickness. After the resin film is gradually heated to 80-120 Celsius in a drying tunnel or oven for a certain period of time, a formed semi-cured film is peeled off from the surface of the support. The semi-cured film is fixed on a needle plate under two-way tensile tension and high-temperature treatment in a drying tunnel is applied with a maximum temperature of not higher than 400 Celsius to obtain a transparent and tint-free polyimide film after cooling with a thickness of 25 μm, a light transmittance at 500 nm of 86.5%, a coefficient of thermal expansion (CTE, 50-200 Celsius) of 26.1 ppm/Celsius, and a tensile modulus of 6.8 GPa.

Example 2: 14.71 g s-BPDA, 9.20 g absolute ethyl alcohol, 15.82 g pyridine and 129 g N-methylpyrrolidone (NMP) are added in a 500 ml three-necked round bottom flask equipped with a mechanical stirrer, thermometer and nitrogen protection device, and stirred for 6 hours at room temperature to form corresponding aromatic diacid diethyl ester solution. At the same time, 11.21 g HPMDA, 9.20 g absolute ethyl alcohol, 1.60 g pyridine and 16 g N-methylpyrrolidone (NMP) are added in a 500 ml three-necked round bottom flask equipped with a mechanical stirrer, thermometer and nitrogen protection device, and stirred for 6 hours at room temperature to form corresponding alicyclic diacid diethyl ester solution. The aromatic diacid diethyl ester solution and the alicyclic diacid diethyl ester solution have separate reactions with 23.79 g of SOCl₂ at a temperature of 0-10 Celsius for 2 hours and at room temperature for 4 hours to for forming corresponding aromatic diacid chloride diethyl ester solution and corresponding alicyclic diacid chloride diethyl eater solution.

28.81 g of TFDB, 4.28 g of 6FAPB, and 158 g NMP are added in a 1 L three-necked round bottom flask equipped with a mechanical stirrer, thermometer and nitrogen protection device, and stirred for to form a homogeneous transparent solution. The temperature of the homogeneous transparent solution is cooled to under 10 Celsius by an ice bath, the tetracid dianhydride derivative is dropped into the homogeneous transparent solution for 0.5 hour. After the reaction for 10 hours at room temperature, the solution reacted is poured into 5 L deionized water, and solids are separated from the solution and filtered, and vacuum dried to obtain primary polyamide ester resin. The primary polyamide ester resin is dissolved in tetrahydrofuran to form a primary polyamide ester resin solution, and then the remnants of metallic or nonmetallic ions in the primary polyamide ester resin solution are removed by adsorption of anions and cations to obtain a high pure presoma of polyimide that is a polyamide ester (PAE) resin.

Dissolving 20.0 g solid resin of PAE in 80.0 g of γ-butyrolactone to form a homogenous resin solution with a solid content of 20 wt. %. The homogenous resin solution is cooled to a temperature of between 1 Celsius to 10 Celsius. And then 20 g mixture of acetic anhydride and pyridine is added to the cooled homogenous resin solution. The solution is mixed evenly, filtered, and vacuum defoamed. The solution is coated on a surface of a glass support to form a resin film with a certain thickness. After the resin film is gradually heated to 60 Celsius for 1 h and to 120 Celsius for 10 min, a formed semi-cured film is peeled off from the surface of the support. Then fixing the semi-cured film surroundings on a stainless steel frame to endure high-temperature treatment in an oven with a temperature of 220 Celsius for 5 min and 400 Celsius for 1 min to obtain a transparent and tint-free polyimide film after cooling with a thickness of 25 μm, a light transmittance at 500 nm of 86.5%, a coefficient of thermal expansion (CTE, 50-200 Celsius) of 26.1 ppm/Celsius, and a tensile modulus of 6.8 GPa.

Example 3: 200 ml DMAc, 22.41 g TFDB and 12.85 g 6FAPB are added in a 500 ml three-necked round bottom flask equipped with a mechanical stirrer, thermometer and nitrogen protection device, and all solids are dissolved under stirring and nitrogen protection to form a homogeneous solution. The above round bottom flask is cooled to 0-10 Celsius with an ice bath, and 11.21 g of HPMDA and 14.71 g of s-BPDA solid powder are added in batches to the above homogeneous solution with stirring. After all solids were completely dissolved, there is a duration of 10 hours for a polycondensation reaction under stirring to obtain a viscous homogeneous polyamide acid (PAA) resin solution.

100 g of the PAA resin solution are taken to a 200 ml glass flask. 20 g mixture of maleic anhydride and isoquinoline is added in the PAA resin solution under stirring. Then the solution is mixed evenly, filtered, and vacuum defoamed. The solution is coated on a surface of a glass support to form a resin film with a certain thickness. After the resin film is gradually heated to 60 Celsius for 1 hour and to 120 Celsius for 10 min, a formed semi-cured film is peeled off from the surface of the support. And then fixing the semi-cured film surroundings on a stainless steel frame to endure high-temperature treatment in an oven with a temperature of 220 Celsius for 5 min and 400 Celsius for 1 min to obtain a transparent and tint-free polyimide film after cooling with a thickness of 25 μm, a light transmittance at 500 nm of 91.2%, a coefficient of thermal expansion (CTE, 50-200 Celsius) of 29.0 ppm/Celsius, and a tensile modulus of 5.0 GPa.

Example 4: 200 ml DMF, 16.01 g TFDB and 21.41 g 6FAPB are added in a 500 ml three-necked round bottom flask equipped with a mechanical stirrer, thermometer and nitrogen protection device, and dissolved all solids under stirring and nitrogen protection to form a homogeneous solution. The above round bottom flask is cooled to 0-10 Celsius with an ice bath, and 2.24 g of HPMDA and 19.63 g of PMDA solid powder are added in batches to the above homogeneous solution with stirring. After all solids were completely dissolved, there is a duration of 10 hours for a polycondensation reaction under stirring to obtain a viscous homogeneous polyamide acid (PAA) resin solution.

100 g of the PAA resin solution are taken to a 200 ml glass flask. 40 g mixture of acetic anhydride and pyridine are added in the PAA resin solution under stirring. Then the solution is mixed evenly, filtered, and vacuum defoamed. The solution is coated on a surface of a glass support to form a resin film with a certain thickness. After the resin film is gradually heated to 60 Celsius for 1 hour and to 120 Celsius for 10 min, a formed semi-cured film is peeled off from the surface of the support. And then fixing the semi-cured film surroundings on a stainless steel frame or under two-way tensile tension to endure high-temperature treatment in an oven with a temperature of 220 Celsius for 5 min and 400 Celsius for 1 min to obtain a transparent and tint-free polyimide film after cooling with a thickness of 25 μm, a light transmittance at 500 nm of 88.6%, a coefficient of thermal expansion (CTE, 50-200 Celsius) of 11.9 ppm/Celsius, and a tensile modulus of 6.5 GPa.

Example 5: 200 ml NMP, 22.41 g TFDB and 12.85 g 6FAPB are added in a 500 ml three-necked round bottom flask equipped with a mechanical stirrer, thermometer and nitrogen protection device, and all solids are dissolved under stirring and nitrogen protection to form a homogeneous solution. The above round bottom flask is cooled to 0-10 Celsius with an ice bath, and 6.72 g of HPMDA and 15.27 g of PMDA solid powder are added in batches to the above homogeneous solution with stirring. After all solids were completely dissolved, there is a duration of 10 hours for a polycondensation reaction under stirring to obtain a viscous homogeneous polyamide acid (PAA) resin solution.

100 g of the PAA resin solution are taken to a 200 ml glass flask. 40 g mixture of acetic anhydride and pyridine are added in the PAA resin solution under stirring. Then the solution is mixed evenly, filtered, and vacuum defoamed. The solution is coated on a surface of a glass support to form a resin film with a certain thickness. After the resin film is gradually heated to 60 Celsius for 1 hour and to 120 Celsius for 10 min, a formed semi-cured film is peeled off from the surface of the support. And then fixing the semi-cured film surroundings on a stainless steel frame or under two-way tensile tension to endure high-temperature treatment in an oven with a temperature of 220 Celsius for 5 min and 400 Celsius for 1 min to obtain a transparent and tint-free polyimide film after cooling with a thickness of 25 μm, a light transmittance at 500 nm of 90.5%, a coefficient of thermal expansion (CTE, 50-200 Celsius) of 14.8 ppm/Celsius, and a tensile modulus of 5.2 GPa.

Example 6: 200 ml DMF, 22.41 g TFDB and 12.85 g 6FAPB are added in a 500 ml three-necked round bottom flask equipped with a mechanical stirrer, thermometer and nitrogen protection device, and all solids are dissolved under stirring and nitrogen protection to form a homogeneous solution. The above round bottom flask is cooled to 0-10 Celsius with an ice bath, and 5.88 g of CBDA and 15.27 g of PMDA solid powder are added in batches to the above homogeneous solution with stirring. After all solids were completely dissolved, there is a duration of 10 hours for a polycondensation reaction under stirring to obtain a viscous homogeneous polyamide acid (PAA) resin solution.

100 g of the PAA resin solution are taken to a 200 ml glass flask. 20 g mixture of acetic anhydride and pyridine are added in the PAA resin solution under stirring. Then the solution is mixed evenly, filtered, and vacuum defoamed. The solution is coated on a surface of a glass support to form a resin film with a certain thickness. After the resin film is gradually heated to 60 Celsius for 1 hour and to 120 Celsius for 10 min, a formed semi-cured film is peeled off from the surface of the support. And then fixing the semi-cured film surroundings on a stainless steel frame or under two-way tensile tension to endure high-temperature treatment in an oven with a temperature of 220 Celsius for 5 min and 400 Celsius for 1 min to obtain a transparent and tint-free polyimide film after cooling with a thickness of 25 μm, a light transmittance at 500 nm of 87.9%, a coefficient of thermal expansion (CTE, 50-200 Celsius) of 17.8 ppm/Celsius, and a tensile modulus of 6.4 GPa.

Example 7: 200 ml DMF, 28.81 g TFDB and 4.28 g 6FAPB are added in a 500 ml three-necked round bottom flask equipped with a mechanical stirrer, thermometer and nitrogen protection device, and all solids are dissolved under stirring and nitrogen protection to form a homogeneous solution. The above round bottom flask is cooled to 0-10 Celsius with an ice bath, and 5.88 g of CBDA and 15.27 g of PMDA solid powder are added in batches to the above homogeneous solution with stirring. After all solids were completely dissolved, there is a duration of 10 hours for a polycondensation reaction under stirring to obtain a viscous homogeneous polyamide acid (PAA) resin solution.

100 g of the PAA resin solution are taken to a 200 ml glass flask. 20 g mixture of acetic anhydride and pyridine are added in the PAA resin solution under stirring. Then the solution is mixed evenly, filtered, and vacuum defoamed. The solution is coated on a surface of a glass support to form a resin film with a certain thickness. After the resin film is gradually heated to 60 Celsius for 1 hour and to 120 Celsius for 10 min, a formed semi-cured film is peeled off from the surface of the support. And then fixing the semi-cured film surroundings on a stainless steel frame or under two-way tensile tension to endure high-temperature treatment in an oven with a temperature of 220 Celsius for 5 min and 400 Celsius for 1 min to obtain a transparent and tint-free polyimide film after cooling with a thickness of 25 μm, a light transmittance at 500 nm of 87.0%, a coefficient of thermal expansion (CTE, 50-200 Celsius) of 8.0 ppm/Celsius, and a tensile modulus of 7.4 GPa.

Example 8: 200 ml DMF, 28.81 g TFDB and 4.28 g 6FAPB are added in a 500 ml three-necked round bottom flask equipped with a mechanical stirrer, thermometer and nitrogen protection device, and all solids are dissolved under stirring and nitrogen protection to form a homogeneous solution. The above round bottom flask is cooled to 0-10 Celsius with an ice bath, and 1.96 g of CBDA and 19.63 g of PMDA solid powder are added in batches to the above homogeneous solution with stirring. After all solids were completely dissolved, there is a duration of 10 hours for a polycondensation reaction under stirring to obtain a viscous homogeneous polyamide acid (PAA) resin solution.

100 g of the PAA resin solution are taken to a 200 ml glass flask. 20 g mixture of acetic anhydride and pyridine are added in the PAA resin solution under stirring. Then the solution is mixed evenly, filtered, and vacuum defoamed. The solution is coated on a surface of a glass support to form a resin film with a certain thickness. After the resin film is gradually heated to 60 Celsius for 1 hour and to 120 Celsius for 10 min, a formed semi-cured film is peeled off from the surface of the support. And then fixing the semi-cured film surroundings on a stainless steel frame or under two-way tensile tension to endure high-temperature treatment in an oven with a temperature of 220 Celsius for 5 min and 400 Celsius for 1 min to obtain a transparent and tint-free polyimide film after cooling with a thickness of 25 μm, a light transmittance at 500 nm of 86.2%, a coefficient of thermal expansion (CTE, 50-200 Celsius) of 4.0 ppm/Celsius, and a tensile modulus of 8.2 GPa.

Example 9: 200 ml DMF, 22.41 g TFDB and 12.85 g 6FAPB are added in a 500 ml three-necked round bottom flask equipped with a mechanical stirrer, thermometer and nitrogen protection device, and all solids are dissolved under stirring and nitrogen protection to form a homogeneous solution. The above round bottom flask is cooled to 0-10 Celsius with an ice bath, and 5.88 g of CBDA and 22.59 g of BTDA solid powder are added in batches to the above homogeneous solution with stirring. After all solids were completely dissolved, there is a duration of 10 hours for a polycondensation reaction under stirring to obtain a viscous homogeneous polyamide acid (PAA) resin solution.

100 g of the PAA resin solution are taken to a 200 ml glass flask. 20 g mixture of acetic anhydride and pyridine are added in the PAA resin solution under stirring. Then the solution is mixed evenly, filtered, and vacuum defoamed. The solution is coated on a surface of a glass support to form a resin film with a certain thickness. After the resin film is gradually heated to 60 Celsius for 1 hour and to 120 Celsius for 10 min, a formed semi-cured film is peeled off from the surface of the support. And then fixing the semi-cured film surroundings on a stainless steel frame or under two-way tensile tension to endure high-temperature treatment in an oven with a temperature of 220 Celsius for 5 min and 400 Celsius for 1 min to obtain a transparent and tint-free polyimide film after cooling with a thickness of 25 μm, a light transmittance at 500 nm of 85.0%, a coefficient of thermal expansion (CTE, 50-200 Celsius) of 30.0 ppm/Celsius, and a tensile modulus of 3.9 GPa.

Example 10: 200 ml DMF, 22.41 g TFDB and 15.13 g 6FAPB are added in a 500 ml three-necked round bottom flask equipped with a mechanical stirrer, thermometer and nitrogen protection device, and all solids are dissolved under stirring and nitrogen protection to form a homogeneous solution. The above round bottom flask is cooled to 0-10 Celsius with an ice bath, and 4.53 g of DNDA and 2.94 g of CBDA and 20.60 g of s-BPDA solid powder are added in batches to the above homogeneous solution with stirring. After all solids were completely dissolved, there is a duration of 10 hours for a polycondensation reaction under stirring to obtain a viscous homogeneous polyamide acid (PAA) resin solution.

100 g of the PAA resin solution are taken to a 200 ml glass flask. 20 g mixture of acetic anhydride and pyridine are added in the PAA resin solution under stirring. Then the solution is mixed evenly, filtered, and vacuum defoamed. The solution is coated on a surface of a glass support to form a resin film with a certain thickness. After the resin film is gradually heated to 60 Celsius for 1 hour and to 120 Celsius for 10 min, a formed semi-cured film is peeled off from the surface of the support and then fixed its surroundings on a stainless steel frame or under two-way tensile tension to endure high-temperature treatment in an oven with a temperature of 220 Celsius for 5 min and 400 Celsius for 1 min to obtain a transparent and tint-free polyimide film after cooling with a thickness of 25 μm, a light transmittance at 500 nm of 89.5%, a coefficient of thermal expansion (CTE, 50-200 Celsius) of 18.6 ppm/Celsius, and a tensile modulus of 5.4 GPa.

Example 11: 200 ml NMP, 22.41 g TFDB and 15.13 g 6FAPB are added in a 500 ml three-necked round bottom flask equipped with a mechanical stirrer, thermometer and nitrogen protection device, and all solids are dissolved under stirring and nitrogen protection to form a homogeneous solution. The above round bottom flask is cooled to 0-10 Celsius with an ice bath, and 7.50 g of BTAH and 22.60 g of s-BPDA solid powder are added in batches to the above homogeneous solution with stirring. After all solids were completely dissolved, there is a duration of 10 hours for a polycondensation reaction under stirring to obtain a viscous homogeneous polyamide acid (PAA) resin solution.

100 g of the PAA resin solution are taken to a 200 ml glass flask. 20 g mixture of acetic anhydride and pyridine are added in the PAA resin solution under stirring. Then the solution is mixed evenly, filtered, and vacuum defoamed. The solution is coated on a surface of a glass support to form a resin film with a certain thickness. After the resin film is gradually heated to 60 Celsius for 1 hour and to 120 Celsius for 10 min, a formed semi-cured film is peeled off from the surface of the support. And then fixing the semi-cured film surroundings on a stainless steel frame or under two-way tensile tension to endure high-temperature treatment in an oven with a temperature of 220 Celsius for 5 min and 400 Celsius for 1 min to obtain a transparent and tint-free polyimide film after cooling with a thickness of 25 μm, a light transmittance at 500 nm of 93.5%, a coefficient of thermal expansion (CTE, 50-200 Celsius) of 22.0 ppm/Celsius, and a tensile modulus of 5.4 GPa.

Comparative example 1: 200 ml DMF, 30.41 g TFDB and 2.14 g 6FAPB are added in a 500 ml three-necked round bottom flask equipped with a mechanical stirrer, thermometer and nitrogen protection device, and all solids are dissolved under stirring and nitrogen protection to form a homogeneous solution. The above round bottom flask is cooled to 0-10 Celsius with an ice bath, and 11.21 g of HPMDA and 10.91 g of PMDA solid powder are added in batches to the above homogeneous solution with stirring. After all solids were completely dissolved, there is a duration of 10 hours for a polycondensation reaction under stirring to obtain a viscous homogeneous polyamide acid (PAA) resin solution.

100 g of the PAA resin solution are taken to a 200 ml glass flask. 20 g mixture of acetic anhydride and pyridine are added in the PAA resin solution under stirring. Then the solution is mixed evenly, filtered, and vacuum defoamed. The solution is coated on a surface of a glass support to form a resin film with a certain thickness. After the resin film is gradually heated to 60 Celsius for 1 hour and to 120 Celsius for 10 min, a formed semi-cured film is peeled off from the surface of the support. And then fixing the semi-cured film surroundings on a stainless steel frame or under two-way tensile tension to endure high-temperature treatment in an oven with a temperature of 220 Celsius for 5 min and 400 Celsius for 1 min to obtain a transparent and tint-free polyimide film after cooling with a thickness of 25 μm, a light transmittance at 500 nm of 83.0%, a coefficient of thermal expansion (CTE, 50-200 Celsius) of 38.5 ppm/Celsius, and a tensile modulus of 5.3 GPa.

Comparative example 2: 200 ml NMP, 1.60 g TFDB and 40.68 g 6FAPB are added in a 500 ml three-necked round bottom flask equipped with a mechanical stirrer, thermometer and nitrogen protection device, and all solids are dissolved under stirring and nitrogen protection to form a homogeneous solution. The above round bottom flask is cooled to 0-10 Celsius with an ice bath, and 11.21 g of HPMDA and 10.91 g of PMDA solid powder are added in batches to the above homogeneous solution with stirring. After all solids were completely dissolved, there is a duration of 10 hours for a polycondensation reaction under stirring to obtain a viscous homogeneous polyamide acid (PAA) resin solution.

100 g of the PAA resin solution are taken to a 200 ml glass flask. 20 g mixture of acetic anhydride and pyridine are added in the PAA resin solution under stirring. Then the solution is mixed evenly, filtered, and vacuum defoamed. The solution is coated on a surface of a glass support to form a resin film with a certain thickness. After the resin film is gradually heated to 60 Celsius for 1 hour and to 120 Celsius for 10 min, a formed semi-cured film is peeled off from the surface of the support. And then fixing the semi-cured film surroundings on a stainless steel frame or under two-way tensile tension to endure high-temperature treatment in an oven with a temperature of 220 Celsius for 5 min and 400 Celsius for 1 min to obtain a transparent and tint-free polyimide film after cooling with a thickness of 25 μm, a light transmittance at 500 nm of 91.8%, a coefficient of thermal expansion (CTE, 50-200 Celsius) of 48.1 ppm/Celsius, and a tensile modulus of 2.8 GPa.

Comparative example 3: 200 ml NMP, 16.01 g TFDB and 21.41 g 6FAPB are added in a 500 ml three-necked round bottom flask equipped with a mechanical stirrer, thermometer and nitrogen protection device, and all solids are dissolved under stirring and nitrogen protection to form a homogeneous solution. The above round bottom flask is cooled to 0-10 Celsius with an ice bath, and 21.29 g of HPMDA and 1.09 g of PMDA solid powder are added in batches to the above homogeneous solution with stirring. After all solids were completely dissolved, there is a duration of 10 hours for a polycondensation reaction under stirring to obtain a viscous homogeneous polyamide acid (PAA) resin solution.

100 g of the PAA resin solution are taken to a 200 ml glass flask. 20 g mixture of acetic anhydride and pyridine are added in the PAA resin solution under stirring. Then the solution is mixed evenly, filtered, and vacuum defoamed. The solution is coated on a surface of a glass support to form a resin film with a certain thickness. After the resin film is gradually heated to 60 Celsius for 1 hour and to 120 Celsius for 10 min, a formed semi-cured film is peeled off from the surface of the support. And then fixing the semi-cured film surroundings on a stainless steel frame or under two-way tensile tension to endure high-temperature treatment in an oven with a temperature of 220 Celsius for 5 min and 400 Celsius for 1 min to obtain a transparent and tint-free polyimide film after cooling with a thickness of 25 μm, a light transmittance at 500 nm of 90.5%, a coefficient of thermal expansion (CTE, 50-200 Celsius) of 52.0 ppm/Celsius, and a tensile modulus of 2.4 GPa.

Comparative example 4: 200 ml NMP, 16.01 g TFDB and 21.41 g 6FAPB are added in a 500 ml three-necked round bottom flask equipped with a mechanical stirrer, thermometer and nitrogen protection device, and all solids are dissolved under stirring and nitrogen protection to form a homogeneous solution. The above round bottom flask is cooled to 0-10 Celsius with an ice bath, and 1.12 g of HPMDA and 20.72 g of PMDA solid powder are added in batches to the above homogeneous solution with stirring. After all solids were completely dissolved, there is a duration of 10 hours for a polycondensation reaction under stirring to obtain a viscous homogeneous polyamide acid (PAA) resin solution.

100 g of the PAA resin solution are taken to a 200 ml glass flask. 20 g mixture of acetic anhydride and pyridine are added in the PAA resin solution under stirring. Then the solution is mixed evenly, filtered, and vacuum defoamed. The solution is coated on a surface of a glass support to form a resin film with a certain thickness. After the resin film is gradually heated to 60 Celsius for 1 hour and to 120 Celsius for 10 min, a formed semi-cured film is peeled off from the surface of the support and then fixed its surroundings on a stainless steel frame or under two-way tensile tension to endure high-temperature treatment in an oven with a temperature of 220 Celsius for 5 min and 400 Celsius for 1 min to obtain a transparent and tint-free polyimide film after cooling with a thickness of 25 μm, a light transmittance at 500 nm of 82.7%, a coefficient of thermal expansion (CTE, 50-200 Celsius) of 36.1 ppm/Celsius, and a tensile modulus of 3.8 GPa.

It can be seen from the table 1 of examples that the transparent and tint-free polyimide film disclosed in the present disclosure not only has excellent transparency, its light transmittance at 500 nm is ≥85%, but also has a high modulus (tensile modulus≥3.5 GPa) and low CTE (≤35 ppm/Celsius, 50-200 Celsius) and other characteristics, with excellent comprehensive performance. The polyimide film prepared in the compared examples may have a higher modulus, but a higher CTE and lower transmittance (comparative example 1 and comparative example 2). Either, the polyimide film prepared in the compared examples have a high light transmittance, but have a higher CTE and a lower modulus (comparative example 2 and comparative example 3). When the mole fraction of TFDB is less than 50% of the total mole fraction of fluorinated aromatic diamine, it will cause a decrease in tensile modulus and an increase in CTE; when it exceeds 90%, it will cause light transmittance drops. When the mole fraction of the alicyclic tetracid dianhydride to the total moles of the tetracid dianhydride is less than 10%, the light transmittance decreases significantly; when it exceeds 50%, it will cause the tensile modulus to decrease and the CTE to increase. It should be noted that, within the setting range of the present disclosure, the proportion of moles of TFDB or/and alicyclic tetracid dianhydride is adjusted, the performance of the final product will change, and the low thermal expansion and high modulus of the final product can be designed on the premise of ensuring transparency. The range of the design is wide.

TABLE 1

| | Light | | |
|---|---|---|---|
| | transmittance, | CTE | Tensile |
| | (% | (ppm/ | modulus |
| NO. | @500 nm) | ° C.) | (GPa) |
| Example 1 | 86.5 | 26.1 | 6.8 |
| Example 2 | 86.5 | 26.1 | 6.8 |
| Example 3 | 91.2 | 29.0 | 5.0 |
| Example 4 | 88.6 | 11.9 | 6.5 |
| Example 5 | 90.5 | 14.8 | 5.2 |
| Example 6 | 87.9 | 17.8 | 6.4 |
| Example 7 | 87.0 | 8.0 | 7.4 |
| Example 8 | 86.2 | 4.0 | 8.2 |
| Example 9 | 85.0 | 30.0 | 3.9 |
| Example 10 | 89.5 | 18.6 | 5.4 |
| Example 11 | 93.5 | 22.0 | 5.4 |
| Comparative | 83.0 | 38.5 | 5.3 |
| example 1 | | | |
| Comparative | 91.8 | 48.1 | 2.8 |
| example 2 | | | |
| Comparative | 90.5 | 52.0 | 2.4 |
| example 3 | | | |
| Comparative | 82.7 | 36.1 | 3.8 |
| example 4 | | | |

In other embodiments of the present disclosure, the fluorinated aromatic diamine may also be a mixture of TFDB and 6FMPB, or a mixture of TFDB and more of 6FAPB, 6FBAB, and 6FMPB. In other embodiments, the alicyclic tetracid dianhydride may also be DMBD, or a mixture of HPMDA, CBDA, DNDA, BTAH, and DMBD. In other embodiments, the aromatic tetracid dianhydride may also be α-BPDA, α-DSDA or s-DSDA, or a mixture of more of PMDA, s-BPDA, α-BPDA, α-DSDA, and s-DSDA. Similarly, the polar aprotic solvent, the organic solvent, etc. are not limited to the situations listed in the above examples, and will not be repeated here.

In summary, the transparent and tint-free polyimide film of the present disclosure not only has excellent transparency, its light transmittance at 500 nm is ≥85%, but also has a high modulus (tensile modulus≥3.8 GPa) and low CTE (≤30 ppm/Celsius, 50-200 Celsius) and can meet the needs of flexible optoelectronic display devices.

The embodiments shown and described above are only examples. Many details are often found in the relevant art, therefore, many such details are neither shown nor described. Even though numerous characteristics and advantages of the embodiments have been set forth in the foregoing description, together with details of the structure and function of the embodiments, the present disclosure is illustrative only, and changes may be made in details, including in the matters of shape, size, and arrangement of parts within the principles of the embodiments to the full extent indicated by the broad general meaning of the terms in which the appended claims are expressed.

What is claimed is:

1. A transparent and tint-free polyimide film comprising following characteristics: a tensile modulus≥3.8 GPa; a coefficient of thermal expansion at 50-200 Celsius≥30 ppm/Celsius; and a light transmittance at 500 nm wavelength≥85%, wherein a polyamide acid resin solution or a polyamide ester resin solution, obtained by a polycondensation reaction between a fluorinated aromatic diamine and one of a tetracid dianhydride and a tetracid dianhydride derivative, reacts with a chemical imidization reagent and then form the transparent and tint-free polyimide film; the tetracid dianhydride is a mixture of an alicyclic tetracid dianhydride and an aromatic tetracid dianhydride; the tetracid dianhydride derivative is a mixture of an alicyclic diacid chloride diester solution produced by the esterification and acid chlorination of an alicyclic tetracid dianhydride, and an aromatic diacid chloride diester solution produced by the esterification and acid chlorination of an aromatic tetracid dianhydride.

2. The transparent and tint-free polyimide film of claim 1, wherein the transparent and tint-free polyimide film has following characteristics: a tensile modulus of 3.8 GPa to 8.5 GPa; a coefficient of thermal expansion at 50-200 Celsius of 1 ppm/Celsius to 30 ppm/Celsius; and a light transmittance at 500 nm wavelength of 85% to 96%.

3. The transparent and tint-free polyimide film of claim 2, wherein the solid content of the polyamide acid resin solution or the polyamide eater resin solution is 15-30 wt. %.

4. The transparent and tint-free polyimide film of claim 3, wherein the molar number of the alicyclic tetracid dianhydride accounts for 10-50% of the sum of the molar number of the alicyclic tetracid dianhydride and the aromatic tetracid dianhydride.

5. The transparent and tint-free polyimide film of claim 3, wherein the aromatic tetracid dianhydride includes one or more of pyromellitic dianhydride, 3,3′,4,4′-biphenyltetracarboxylic dianhydride, 2,3,3′,4′-biphenyltetracarboxylic dianhydride, 3,3′,4,4′-diphenylsulfone tetracarboxylic dianhydride, 2,3,3′,4′-diaphenylsulfone tetracarboxylic dianhydride.

6. The transparent and tint-free polyimide film of claim 3, wherein the alicyclic tetracid dianhydride includes 1,8-dimethylbicyclo[2,2,2]oct-7-ene-2,3,5,6-tetracarboxylic dianhydride, 1,4,5,8-dimethylene bridge-perhydronaphthalene-2,3,6,7-tetracarboxylic acid dianhydride, bicyclo[2,2,2]octane-2,3,5,6-tetracarboxylic dianhydride, cyclic hexane-1,2,4,5-tetracarboxylic dianhydride and cyclobutane-1,2,3,4-tetracarboxylic dianhydride.

7. The transparent and tint-free polyimide film of claim 3, wherein the fluorinated aromatic diamine maily includes 2,2′-bistrifluoromethyl-4,4′-diaminobiphenyl, and one or more of 1,4-bis(2-trifluoromethyl-4-aminophenoxygroup)benzene, 1,3-bis(2-trifluoromethyl-4-aminophenoxy)benzene, 4,4′-bis(2-trifluoromethyl-4-aminophenoxy)biphenyl; where the molar number of 2,2′-bistrifluoromethyl-4,4′-diaminobiphenyl accounts for 50% to 90% of the total molar number of the fluorinated aromatic diamine.

8. The transparent and tint-free polyimide film of claim 3, wherein a polar aprotic solvent is also added to the polycondensation reaction between the fluorinated aromatic diamine and the tetracid dianhydride; the polar aprotic solvent includes one or more of N-methylpyrrolidone, N,N′-diamethyl acetamide, N,N′-diamethylformamide and diamethyl dulfoxide.

9. The transparent and tint-free polyimide film of claim 3, wherein the esterification reaction to obtain the tetracid dianhydride derivative further includes an organic solvent, and the organic solvent includes one or more of N-methylpyrrolidone, N,N′-dimethylacetamide, N,N′-dimethylformamide, dimethyl sulfoxide, γ-butyrolactone, ethyl lactate, cyclopentanone, cyclohexanone, methyl ethyl ketone, ethyl acetate, and butyl acetate.

10. The transparent and tint-free polyimide film of claim 3, wherein the chemical imidization reagent includes an organic acid anhydride and an organic base; the organic acid anhydride includes one or more of acetic anhydride, propionic anhydride, butyric anhydride, benzoic anhydride, and maleic anhydride; the organic base includes pyridine, 2-picoline, 3-picoline, and isoquinoline.

11. A preparation method for a transparent and tint-free polyimide film comprises:
preparing a tetracid dianhydride and a tetracid dianhydride derivative, wherein the tetracid dianhydride including an alicyclic tetracid dianhydride and an aromatic tetracid dianhydride; the tetracid dianhydride derivative being a mixture of an alicyclic diacid chloride diester solution obtained by reaction with the esterification and acid chlorination of an alicyclic tetracid dianhydride in an organic solvent, and an aromatic diacid chloride diester solution obtained by reaction with the esterification and acid chlorination of an aromatic tetracid dianhydride in an organic solvent;
adding a fluorinated aromatic diamine into a polar aprotic solvent to form a homogeneous solution, and then adding a tetracid dianhydride in batches into the homogeneous solution to form a polyamide acid resin solution through polycondensation reaction between the fluorinated aromatic diamine and the tetracid dianhydride; or adding a fluorinated aromatic diamine into the tetracid dianhydride derivative to form a polyamide ester resin solution with polycondensation reaction between the fluorinated aromatic diamine and the tetracid dianhydride derivative, and purification;
adding a chemical imidization reagent into the polyamide acid resin solution or the polyamide ester resin solution, and that being stirred evenly, and vacuum defoamed, and coated on a surface of a support, and forming a semi-cured self-supporting adhesive film after heat treatment;
peeling off the semi-cured self-supporting adhesive film from the surface of the support, fixing the surroundings of the semi-cured self-supporting adhesive film or stretching biaxially the semi-cured self-supporting adhesive film at high temperature treatment to complete the imidization reaction; and cooling to obtain the transparent and tint-free polyimide film.

12. The preparation method for a transparent and tint-free polyimide film of claim 11, wherein an alicyclic tetracid dianhydride and an aromatic tetracid dianhydride are each dissolved in an organic solvent with a low-fat alcohol, and an esterification reaction takes place under heating to form an alicyclic diacid diester solution and an aromatic diacid diester solution; and then, sulfoxide chlorides are added respectively for chlorination reactions so that the alicyclic diacid diester solution and the aromatic diacid diester solution are converted to an alicyclic diester chloride diester solution and an aromatic diester chloride diester solution respectively; the alicyclic diester chloride diester solution and the aromatic diester chloride diester solution are mixed to obtain the tetracid dianhydride derivative.

13. The preparation method for a transparent and tint-free polyimide film of claim 11, wherein the purification comprises precipitating, filtering and washing the solution formed by the polycondensation reaction between the fluorinated aromatic diamine and the tetracid dianhydride derivative to obtain first resin solids; dissolving first resin solids in an organic solvent to form a homogenous solution, and purifying the homogenous solution by ion adsorption, separating out, and drying to obtain second resin solids; dissolving second resin solids in an organic solvent to form the polyamide ester resin solution.

14. An optical polyimide film comprises a metal layer, an indium tin oxide transparent electrode and a transparent and tint-free polyimide film, the metal layer is deposited by ion implantation or magnetron sputtering on one side or both sides of the transparent and tint-free polyimide film activated, the indium tin oxide transparent electrode is vacuum deposited on the surface of the metal layer facing away from the transparent and tint-free polyimide film; wherein the transparent and tint-free polyimide film comprises following characteristics: a tensile modulus of 3.8 GPa to 8.5 GPa; a coefficient of thermal expansion at 50-200 Celsius of 1 ppm/Celsius to 30 ppm/Celsius; and a transmittance at 500 nm wavelength of 85% to 96%.

15. The optical polyimide film of claim 14, wherein the optical polyimide film is applied to but not limited to a flexible transparent optoelectronic display substrate, a flexible optoelectronic display protective film or a flexible electronic packaging substrate.
